(19) United States
(12) Patent Application Publication
(10) Pub. No.: US 2019/0071240 A1
(43) Pub. Date: Mar. 7, 2019

(54) Food wrap organizer and storage bag dispenser

(71) Applicant: Ashmeen Modikhan, Ozone Park, NY (US)

(72) Inventor: Ashmeen Modikhan, Ozone Park, NY (US)

(21) Appl. No.: 15/932,225

(22) Filed: Feb. 16, 2018

Related U.S. Application Data
(60) Provisional application No. 62/459,874, filed on Feb. 16, 2017.

(51) Int. Cl. B65D 83/08; B26F 3/02

(52) U.S. Cl. CPC B65D 83/0841; B26F 3/02

(57) ABSTRACT

A food wrap organizer and storage bag dispenser providing a wall- or door-mounted receptacle specially designed for the management of food preserving bags and wraps.

### CLAIM OF PRIORITY

This patent application claims priority under 35 USC 119 (e) (1) from U.S. Provisional Patent Application Ser. No. 62/459,874 filed Feb. 16, 2017, of common inventorship herewith entitled, “Food Wrap Organizer and Storage Bag Dispenser,” which is incorporated herein by reference as though the same were set forth in its entirety.

### FIELD OF THE INVENTION

The present invention pertains to the field of a food wrap organizer and storage bag dispenser, and more specifically to the field of a food wrap organizer and storage bag dispenser providing a wall- or door-mounted receptacle specially designed for the management of food preserving bags and wraps.

### BACKGROUND OF THE INVENTION

As the cost of dining out continues to spiral, many Americans are endeavoring to prepare their own snacks and lunches to take with them to work or school. Whether brown-bagging a hastily prepared sandwich, spooning leftovers from the night before into a portable food dish, or filling a child's lunch box with a combination of yummy and nutritious food items, consumers spend a significant portion of their mornings packing sustenance to enjoy later in the day. This practice not only saves money, but also accommodates time constraints that may not allow busy people to spend a leisurely hour in a restaurant at noontime.

Leftovers, especially, provide the most economical means of supplying a daily lunch or even a repeat performance at the next night's dinner. Even so, those who endeavor not to waste food by storing leftovers in the refrigerator for later enjoyment do face an obstacle. Particularly, the many wraps and storage bags needed for preserving the foods can present quite the organizational challenge. From rolls of aluminum foil and reams of plastic cling wrap to boxes of various-sized, zipper-enhanced storage bags, drawers and cabinets are commonly filled to bursting with product. When hurriedly cleaning after dinner or putting together a child's lunch on busy mornings, it can be frustrating seeking out the needed wrap or bag for one's particular preservation purpose.

The prior art has put forth several designs for food wrap organizers. Among these are:

U.S. Pat. No. 7,784,625 describes an organizer configured to store and organize storage article product packages. The organizer has a first storage bin with a front panel and is configured to hold one or more storage article product packages which can dispense individual storage articles through a dispenser opening. The first storage bin is mountable to a generally vertical mounting surface. An opening in the front panel of the first storage bin is positioned to align with the dispenser openings of the one or more product packages. A second storage bin has a front panel, an open top, and a bottom and is configured to hold one or more elongate product packages in a vertical orientation and accessible via the open top. The second storage bin is mountable to the mounting surface and can pivot forward from and rearward back toward the generally vertical surface.

U.S. Pat. No. 4,094,416 to James A. Smith describes A panel body portion can be attached to a wall or to the inside of a kitchen cabinet door. The panel body portion can include a rear compartment for loose paper bags and the like defined by marginal flanges which cause the panel body portion to stand off from the supporting door or wall. Two way adjustable holders for dispensing packages of various sizes and types are mounted on the panel body portion at a plurality of elevations. Packages for foil, plastic wrap, wax paper and various types of bags are accommodated by the invention. Each holder embodies end holder units whose spacing may be varied longitudinally of the package and whose width may also be varied to accommodate packages of varying widths.

U.S. Pat. No. D544,262 to Frank Blateri describes a storage system.

### SUMMARY OF THE INVENTION

It is an object of the present invention to provide a food wrap organizer and storage bag dispenser providing a wall- or door-mounted receptacle specially designed for the management of food preserving bags and wraps.

### BRIEF DESCRIPTION OF THE DRAWINGS

FIG. 1 is a perspective view illustrating a food wrap organizer and storage bag dispenser, constructed in accordance with the present invention, with a dispenser for small storage bags, large storage bags, plastic wrap, wax wrap, and foil with a window in each dispenser.

FIG. 2 is another perspective view illustrating the food wrap organizer and storage bag dispenser of FIG. 1, constructed in accordance with the present invention, with at least one of the dispensers having a cutting blade.

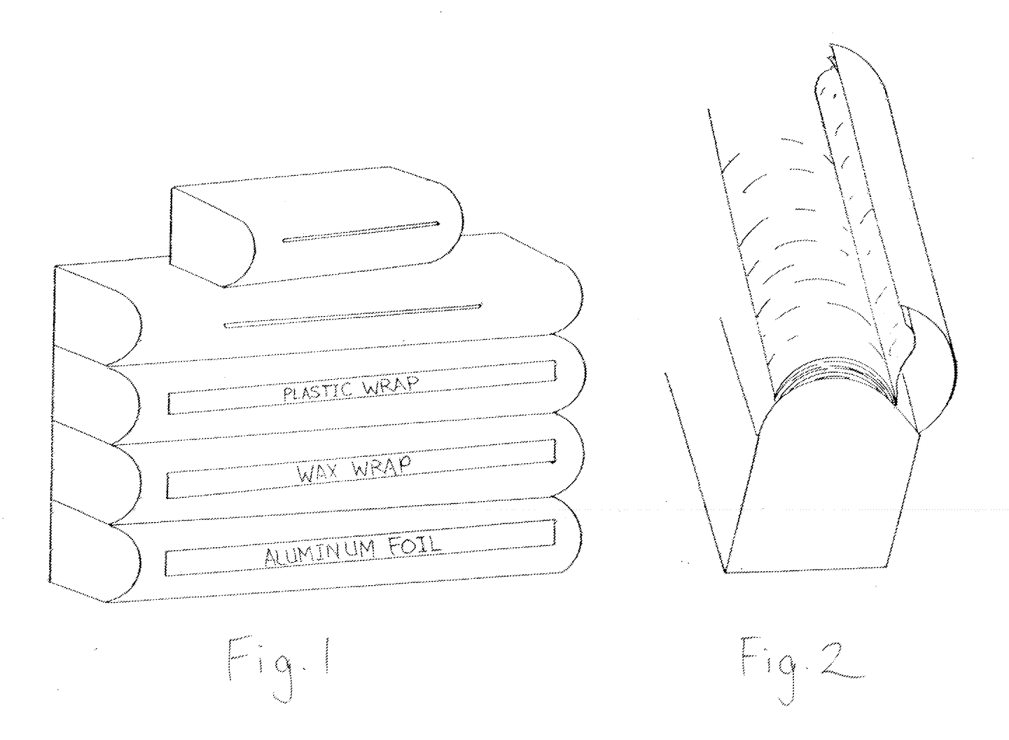

### DETAILED DESCRIPTION OF THE INVENTION

The present invention, hereinafter referred to as a Food Wrap Organizer & Storage Bag Dispenser. The Food Wrap Organizer & Storage Bag Dispenser is a wall- or door-mounted receptacle specially designed for the management of food preserving bags and wraps. Fabricated of a durable plastic or possibly rubber material, the Food Wrap Organizer & Storage Bag Dispenser is preferably rectangular in shape, measuring approximately three feet (3′) in length, two feet (2′) in width, and six inches (6′) in depth. Such a copiously sized unit would be ideal for housing a plethora of bag and wrap needs.

To reflect its capacity, the Food Wrap Organizer & Storage Bag Dispenser is configured with a plurality of elongated slots expressly provided for food wraps such as aluminum foil and plastic, along with food prep rolls such as wax paper and parchment paper. Directly below, two (2) additional slots are available for housing storage bags. For example, one slot can be accorded to sandwich-sized bags, while the other could hold larger freezer bags. As the title of this invention states, the Food Wrap Organizer & Storage Bag Dispenser serves as a handy dispenser, as well. Once the open boxes of wraps and bags are placed into their assigned slots, the top section of wrap or first bag would be pulled outward through the egress. In this manner, one need only grab a needed wrap or bag directly from the container.

As mentioned above, the Food Wrap Organizer & Storage Bag Dispenser is neatly mounted onto a section of wall or onto the door of a pantry. With easy installation hardware included, the Food Wrap Organizer & Storage Bag Dispenser can be affixed into a desired spot, loaded, and ready for use in a matter of minutes.

Indeed, the Food Wrap Organizer & Storage Bag Dispenser provides a practical and innovative system that serves as an all-in-one station for any food preservation accessory needed in the kitchen. Collating all boxes of foils, wraps, and bags into one central location, the Food Wrap Organizer & Storage Bag Dispenser effectively eliminates the disorganized clutter that multiple products can create in the kitchen. As such, the Food Wrap Organizer & Storage Bag Dispenser proves the perfect unit for helping create a well-organized, effortlessly productive kitchen area. With any needed bag or wrap readily within reach, users need not worry about searching through piles of boxes to find a sheath of aluminum foil or a couple of sandwich bags. Perfect for household use, the Food Wrap Organizer & Storage Bag Dispenser also benefits restaurant kitchens, as these highly busy areas are always on the lookout for products that improve efficiency. Affordably priced upon development, the Food Wrap Organizer & Storage Bag Dispenser is sure to be embraced by both the user and commercial sectors.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A food wrap organizer and storage bag dispenser providing a wall- or door-mounted receptacle specially designed for the management of food preserving bags and wraps.
